(19) United States
(12) Patent Application Publication
(10) Pub. No.: US 2005/0283519 A1
(43) Pub. Date: Dec. 22, 2005

(54) Methods and systems for combating spam

(75) Inventors: Yehuda Turgeman, Alfei Menashe (IL); David Dbai, Kfar Yona (IL); Amir Lev, Ein Vered (IL)

Correspondence Address: DARBY & DARBY P.C., P. O. BOX 5257, NEW YORK, NY, 10150-5257, US

(73) Assignee: COMMTOUCH SOFTWARE, LTD., Netanya (IL)

(21) Appl. No.: 11/155,022

(22) Filed: Jun. 15, 2005

Related U.S. Application Data
(60) Provisional application No. 60/580,774, filed on Jun. 17, 2004.

(51) Int. Cl. G06F 15/16

(52) U.S. Cl. 709/206; 715/500; 715/530; 707/104.1

(57) ABSTRACT

A system and method for combating spam, the method including performing bulk transmission detection on incoming messages, performing characteristic-based classification on at least one incoming message and employing results of both the bulk transmission detection and the characteristic-based classification for filtering at least one incoming message.

### FIELD OF THE INVENTION

The present invention relates to methods and systems for combating span generally.

### BACKGROUND OF THE INVENTION

The following U.S. Patents are believed to represent the state of the art: U.S. Pat. Nos. 6,330,590; 6,421,709; 6,453,327; 6,460,050 and 6,622,909.

### SUMMARY OF THE INVENTION

The present invention seeks to provide improved methods and systems for combating spam.

There is thus provided in accordance with a preferred embodiment of the present invention a method for combating spam including performing bulk transmission detection on incoming messages, performing characteristic-based classification on at least one incoming message and employing results of both the bulk transmission detection and the characteristic -based classification for filtering at least one incoming message.

There is also provided in accordance with another preferred embodiment of the present invention a system for combating spam including a bulk transmission detector, operative to perform bulk transmission detection on incoming messages, a characteristic-based classifier, operative to perform characteristic-based classification on at least one incoming message and a filter, operative to employ results of both the bulk transmission detection and the characteristic-based classification for filtering at least one incoming message.

In accordance with another preferred embodiment of the present invention the filtering incoming messages operates on at least one incoming message which is at least partially different from the incoming messages on which the bulk transmission detection is performed and the at least one incoming message on which the characteristic -based classification is performed.

In accordance with still another preferred embodiment of the present invention the performing bulk transmission detection is performed on first incoming messages, the performing characteristic-based classification is performed on at least one second incoming message and the filtering is performed on at least one third incoming message, wherein the at least one third incoming message is at least partially different from at least one of the first incoming messages and the at least one second incoming message. Additionally or alternatively, the performing bulk transmission detection and the performing characteristic classification employ at least some of the same characteristics.

In accordance with yet another preferred embodiment of the present invention the performing characteristic-based classification includes a training functionality. Preferably, the training functionality employs at least some of the results of the performing bulk transmission detection.

In accordance with another preferred embodiment of the present invention at least some of the results of the characteristic -based classification are employed in the bulk transmission detection. Additionally, the results of the characteristic -based classification are employed for distinguishing between different categories of bulk transmissions. Alternatively, the results of the characteristic-based classification are employed for distinguishing between solicited and non-solicited bulk transmissions.

In accordance with still another preferred embodiment of the present invention the characteristic -based classification employs Bayesian probability models.

In accordance with yet another preferred embodiment of the present invention the performing bulk transmission classification includes classifying a message at least partially by evaluating at least one message parameter, using at least one variable criterion, thereby providing a spam classification. Additionally, the at least one variable criterion includes a criterion which changes over time. Alternatively or additionally, the at least one variable criterion includes a parameter template -defined function.

In accordance with a further preferred embodiment of the present invention the filtering includes evaluating incoming messages at at least one gateway and providing spam classifications at at least one server, receiving evaluation outputs from the at least one gateway and providing the spam classifications to the at least one gateway. Additionally, the receiving evaluation outputs includes transmitting encrypted information from the at least one gateway to the at least one server. Additionally, the transmitting encrypted information includes encrypting at least part of the evaluation output employing a non-reversible encryption algorithm so as to generate the encrypted information at the at least one gateway. Additionally, the transmitting includes transmitting information of a length limited to a predefined threshold.

In accordance with another preferred embodiment of the present invention the filtering at least one incoming message includes at least one of: forwarding the message to an addressee of the message, storing the message in a predefined storage area, deleting the message, rejecting the message, sending the message to an originator of the message and delaying the message for a period of time and thereafter re-classifying the message.

In accordance with another preferred embodiment of the present invention the system also includes at least one of a forwarder, operative to forward the message to an addressee of the message, a storing module, operative to store the message in a predefined storage area, a deleting module, operative to delete the message, a rejecting module, operative to reject the message, a sender, operative to send the message to an originator of the message and a delaying module, operative to delay the message for a period of time and thereafter re-classifying the message.

In accordance with yet another preferred embodiment of the present invention the incoming messages include at least one of: an e-mail, a network packet, a digital telecom message and an instant messaging message.

In accordance with still another preferred embodiment of the present invention the filtering also includes at least one of: requesting feedback from an addressee of the message, evaluating compliance of the message with a predefined policy, evaluating registration status of at least one registered address in the message, analyzing a match among network references in the message, analyzing a match between at least one translatable address in the message and at least one other network reference in the message, at least partially actuating an unsubscribe feature in the message, analyzing an unsubscribe feature in the message, employing a variable criteria, sending information to a server and receiving classification data based on the information, employing classification data received from a server and employing stored classification data.

In accordance with another preferred embodiment of the present invention the performing bulk transmission detection includes classifying messages at least partially by evaluating at least one message parameter of multiple messages. Additionally, the classifying messages is at least partially responsive to similarities between plural messages among the multiple messages, which similarities are reflected in the at least one message parameter. Alternatively or additionally, the classifying messages is at least partially responsive to similarities between plural messages among the multiple messages, which similarities are reflected in outputs of applying at least one evaluation criterion to the at least one message parameter.

In accordance with another preferred embodiment of the present invention the classifying messages is at least partially responsive to similarities in multiple outputs of applying a single evaluation criterion to the at least one message parameter in multiple messages. Additionally or alternatively, the classifying messages is at least partially responsive to the extent of similarities between plural messages among the multiple messages which similarities are reflected in the at least one message parameter. In accordance with still another preferred embodiment of the present invention, the classifying messages is at least partially responsive to the extent of similarities between plural messages among the multiple messages which similarities are reflected in outputs of applying at least one evaluation criterion to the at least one message parameter. Alternatively or additionally, the classifying messages is at least partially responsive to the extent of similarities in multiple outputs of applying a single evaluation criterion to the at least one message parameter in multiple messages.

In accordance with another preferred embodiment of the present invention the extent of similarities includes a count of messages among the multiple messages which are similar.

In accordance with yet another preferred embodiment of the present invention the classifying messages is at least partially responsive to similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of similarities among the multiple messages.

In accordance with another preferred embodiment of the present invention the classifying messages also includes aggregating individual similarities among the plurality of similarities. Additionally, the aggregating individual similarities among the plurality of similarities includes applying weights to the individual similarities. Alternatively, the aggregating individual similarities among the plurality of similarities includes calculating a polynomial over the individual similarities.

In accordance with another preferred embodiment of the present invention the classifying messages is at least partially responsive to extents of similarities in outputs of applying evaluation criteria to the at least one message parameter in multiple messages, wherein a plurality of different evaluation criteria are individually applied to the at least one message parameter in the multiple messages, yielding a corresponding plurality of outputs indicating a corresponding plurality of extents of similarities among the multiple messages.

In accordance with another preferred embodiment of the present invention the classifying messages also includes aggregating individual exterts of similarities among the plurality of extents of similarities. Additionally, the aggregating individual extents of similarities among the plurality of extents of similarities includes applying weights to the individual extents similarities. Alternatively, the aggregating individual extents of similarities among the plurality of extents of similarities includes calculating a polynomial over the individual extents of similarities. In accordance with another preferred embodiment of the present invention the extents of similarities includes a count of messages among the multiple messages which are similar.

In accordance with another preferred embodiment of the present invention the at least one evaluation criterion includes a parameter template-defined function.

In accordance with another preferred embodiment of the present invention the classifying messages includes employing a function of outputs of evaluating at least one message parameter of the multiple messages. In accordance with yet another preferred embodiment of the present invention the classifying messages is at least partially responsive to similarities between outputs of the evaluating at least one message parameter of multiple messages.

In accordance with still another preferred embodiment of the present invention the filtering also includes categorizing incoming messages received at at least one gateway into at least first, second and third categories, providing spam classifications for incoming messages in at least the first and second categories, not immediately providing a spam classification for incoming messages in the third category, storing incoming messages in the third category and thereafter providing spam classifications for the incoming messages in the third category. In accordance with another preferred embodiment of the present invention the providing spam classifications for the incoming messages in the third category also includes providing a spam classification for a second message received at the at least one gateway.

In accordance with another preferred embodiment of the present invention the method also includes waiting up to a predetermined period of time between the providing spam classifications for incoming messages in at least the first and second categories and the thereafter providing a spam classification for the incoming messages in the third category.

In accordance with yet another preferred embodiment of the present invention the filter is operative to wait for up to a predetermined period of time between the providing spam classifications for incoming messages in at least the first and second categories and the thereafter providing a spam classification for the incoming messages in the third category.

In accordance with still another preferred embodiment of the present invention the filtering also includes classifying a message at least partially by relating to an unsubscribe feature in the message, thereby providing spam classifications for the message. Additionally, the classifying a message at least partially by relating to an unsubscribe feature in the message also includes identifying whether the message includes an unsubscribe feature. Alternatively or additionally, the classifying a message at least partially by relating to an unsubscribe feature in the message also includes identifying whether the unsubscribe feature includes a reference to an addressee of the message.

In accordance with another preferred embodiment of the present invention the reference to an addressee of the message includes an e-mail address. Alternatively, the reference to an addressee of the message includes a per-addressee generated ID. Additionally, the per-addressee generated ID includes a user identification number.

In accordance with yet another preferred embodiment of the present invention the filtering also includes classifying a message at least partially by at least partially actuating an unsubscribe feature in the message, thereby providing spam classifications for the messages. Additionally, the classifying a message at least partially by at least partially actuating an unsubscribe feature in the message includes analyzing an output of the at least partially actuating. In accordance with another preferred embodiment of the present invention the analyzing an output of the at least partially actuating includes sensing whether part of the output indicates the occurrence of an error. Additionally, the at least partially actuating also includes at least attempting communication with a network server. In accordance with another preferred embodiment of the present invention the error indicates that the network server does not exist. Alternatively, the error indicates that the network server does not provide an unsubscribe functionality. In accordance with another preferred embodiment of the present invention the error indicates that the network server cannot unsubscribe a message addressee.

In accordance with still another preferred embodiment of the present invention the analyzing an output of the at least partially actuating includes sensing whether part of the output includes an addressee reference. Additionally, the addressee reference includes an e-mail address. Alternatively, the addressee reference includes a per-addressee generated ID. Additionally, the per-addressee generated ID includes a user identification number.

In accordance with still another preferred embodiment of the present invention the analyzing an output of the at least partially actuating also includes relating the addressee reference to at least one addressee reference characteristic of the message. Additionally, the at least one addressee reference characteristic of the message includes an e-mail address. Alternatively, the at least one addressee reference characteristic of the message includes at least one per-addressee generated ID. Additionally, the per-addressee generated ID includes a user identification number.

In accordance with still another preferred embodiment of the present invention the classifying a message at least partially by relating to an unsubscribe feature in the message also includes recognizing the unsubscribe feature. Additionally, the recognizing the unsubscribe feature includes sensing a part of the message including predefined keywords. Alternatively, the recognizing the unsubscribe feature includes sensing a part of the message including a network reference and a reference to an addressee of the messages. Additionally, the network reference includes a reference to a network server. In accordance with another preferred embodiment of the present invention the reference to an addressee of the message includes an addressee e-mail address.

In accordance with yet another preferred embodiment of the present invention the filtering also includes classifying a message at least partially by relating to registration status of at least one registered address in the message, thereby providing a spam classification for the message. Additionally, the classifying a message at least partially by relating to registration status of at least one registered address in the message includes employing a network service for determining the registration status. In accordance with another preferred embodiment of the present invention the registration status includes a registration date. Additionally or alternatively, the registration status includes a registration expiry date. In accordance with still another preferred embodiment of the present invention the classifying a message at least partially by relating to registration status of at least one registered address in the message includes inspecting whether registration of the registered address has expired. In accordance with yet another preferred embodiment of the present invention the classifying a message at least partially by relating to registration status of at least one registered address in the message includes inspecting whether the registered address has not been registered.

In accordance with still another preferred embodiment of the present invention the classifying a message at least partially by relating to registration status of at least one registered address in the message includes comparing the registration date to a predefined date. In accordance with another preferred embodiment of the present invention the predefined date is a current date.

In accordance with another preferred embodiment of the present invention the registered address includes an Internet domain name. In accordance with yet another preferred embodiment of the present invention the Internet domain name is parked.

In accordance with another preferred embodiment of the present invention the filtering also includes classifying a message at least partially by relating to a match among network references in the message, thereby providing a spam classification for the message. In accordance with still another preferred embodiment of the present invention the network references include at least one translatable network address and wherein the match is between at least one translatable network address and another at least one of the network references. Preferably, the at least one translatable network address includes a registered network address. Alternatively, the at least one translatable network address includes an Internet domain name.

In accordance with yet another preferred embodiment of the present invention the classifying a message at least partially by relating to a match among network references in the message also includes translating the translatable network address, thereby providing a translated network address.

### BRIEF DESCRIPTION OF THE DRAWINGS

The present invention will be understood and appreciated more fully from the following detailed description, taken in conjunction with the drawings in which:

FIG. 1 is a simplified symbolic illustration of a methodology for combining spam employing both bulk transmission detection and characteristic classificationion, in accordance with a preferred embodiment of the present invention;

FIG. 2 is a simplified symbolic illustration of a methodology for combating spam, employing both bulk transmission detection and characteristic classification and utilizing a training finctionality employing results of bulk transmission detection, in accordance with another preferred embodiment of the present invention;

FIG. 3 is a simplified symbolic illustration of an additional methodology for combating spam, employing both bulk transmission detection and characteristic classification in sequence, in accordance with yet another preferred embodiment of the present invention;

FIGS. 4A-4C are simplified symbolic illustrations of a further methodology for combating spam, employing bulk transmission detection, in accordance with still another preferred embodiment of the present invention; and

FIG. 4D is a simplified flowchart illustrating the functionality of the embodiment of FIGS. 4A-4C.

### DETAILED DESCRIPTION OF PREFERRED EMBODIMENTS

It is appreciated that throughout the specification and claims the term “spam” refers to an unsolicited transmission of a message.

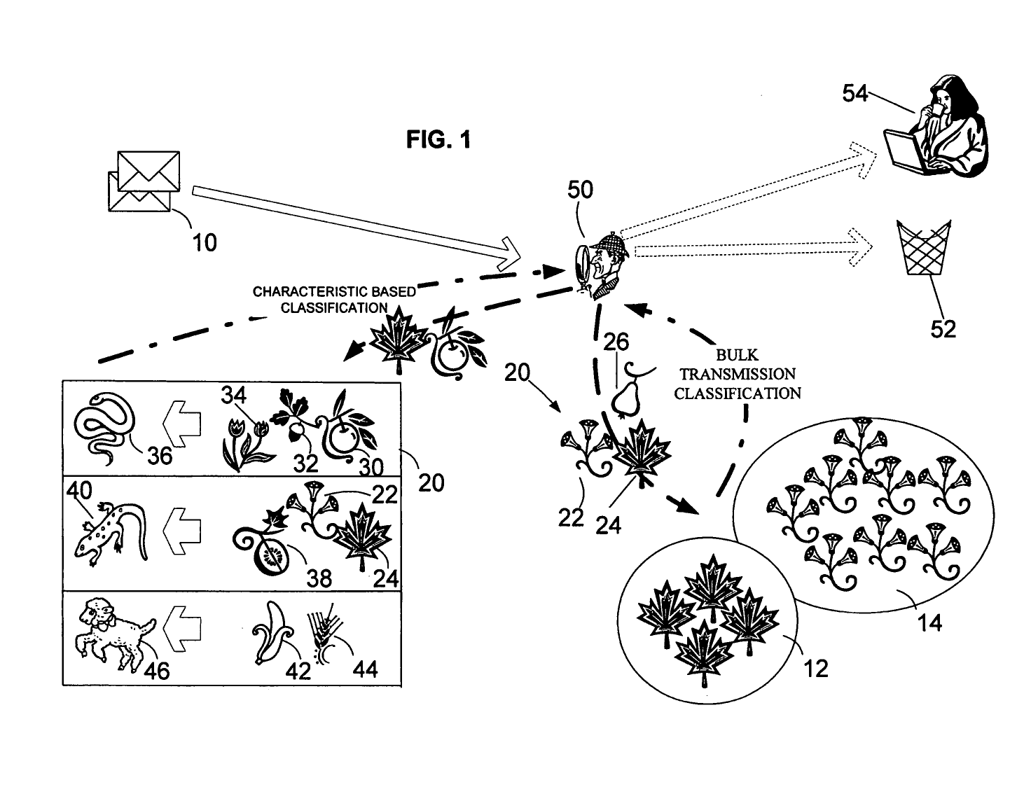

Reference is now made to FIG. 1, which is a simplified symbolic illustration of methodology for combating spam which employs both bulk transmission detection and characteristic-based classification, in accordance with a preferred embodiment of the present invention. As seen in FIG. 1, there is provided a method for combating spam including performing bulk transmission detection on incoming messages 10 and performing characteristic-based classification on at least one incoming message 10 and employing results of both bulk transmission detection and characteristic-based classification for filtering at least one incoming message 10.

In the embodiment of FIG. 1, bulk transmission detection is effected by counting messages in which given characteristics appear, symbolized in FIG. 1 by groups 12 and 14 of images of flora, each different image corresponding to a different characteristic, the number of images in each group indicating the number of incoming messages having each corresponding given characteristic.

An incoming message 10 has characteristics generally indicated by reference numeral 20, such as a specific subject symbolized by a flower 22, a specific type of attachment symbolized by a leaf 24 and a specific result of application of a function template, symbolized by a pear 26. It is seen that in the illustrated example, characteristics symbolized by flower 22 and by leaf 24 have been noted in a plurality of received messages, indicating a relatively high bulk transmission classification, and the characteristic symbolized by pear 26 has not been noted in received messages.

It is appreciated that the presence in an incoming message 10 of at least one characteristic which has been noted in a plurality of received messages may be sufficient to engender a relatively high bulk transmission classification, irrespective of whether other characteristics of the incoming message have also been noted in a plurality of received messages. It is appreciated that presence in an incoming message 10 of multiple characteristics which have been noted in a plurality of received messages may increase the bulk transmission classification of the message to a level higher than that which would result from the presence of any single characteristic therein.

In the embodiment of FIG. 1, characteristic -based classification is effected by utilizing empirical data assigning each of a number of characteristics which appear in incoming messages to a spam classification level. In FIG. 1, it is seen that characteristics such as the word “sex”, symbolized by an apple 30, a message whose body consists of an image, symbolized by an acorn 32 and a non-existent source address, symbolized by tulips 34 are each assigned a high spam classification level, symbolized by a snake 36.

Characteristics such as the phrase “stock option”, symbolized by leaf 24, a message in HTML format, symbolized by flower 22 and very short message, symbolized by a melon 38 are each assigned an indeterminate spam classification level, symbolized by a chameleon 40.

Characteristics such as the word “interdisciplinary”, symbolized by a banana 42 and the names of the recipient's children, symbolized by wheat 44 are each assigned a low spam classification level, symbolized by a lamb 46.

It is appreciated that characteristic -based classification may comprise analysis based on Bayesian probability models of spam and non-spam words.

Spam decision functionality, symbolized by a detective 50, receives bulk transmission classification inputs from transmission detection functionality and receives characteristic -based classification inputs from characteristic -based classification functionality and makes a spam/no spam decision based on these inputs. If an incoming message is determined to be spam, it is deleted, as symbolized by an arrow pointing to a trash bin 52. If an incoming message is determined not to be spam it is sent to a recipient 54.

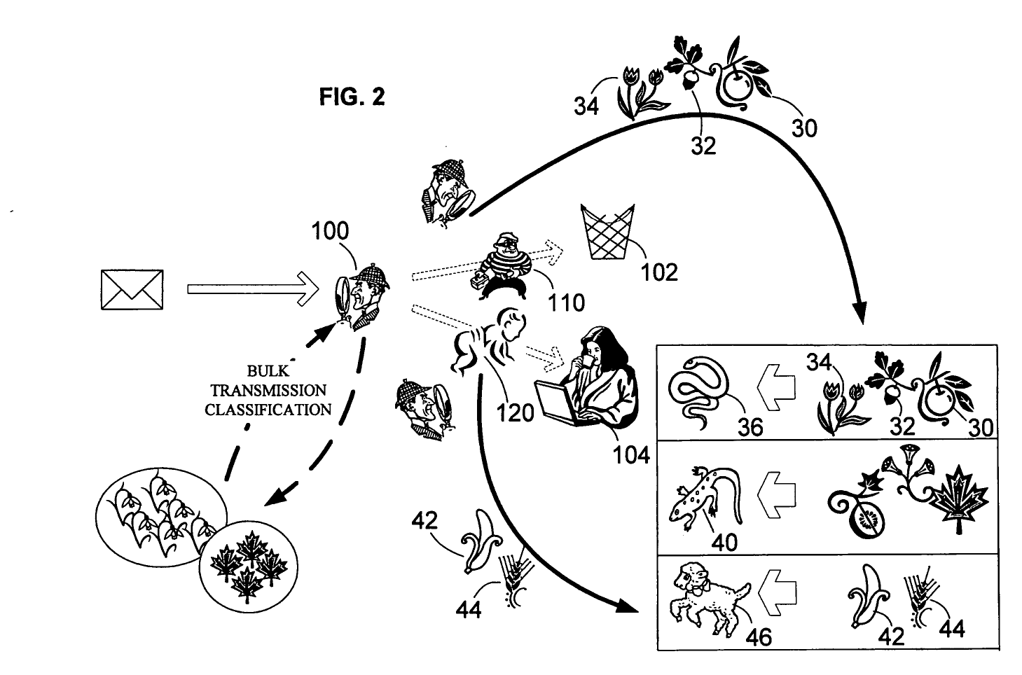

Reference is now made FIG. 2, which is a simplified symbolic illustration of methodology for combating spam which employs both bulk transmission detection and characteristic-based classification and utilizes a training functionality which employs results of bulk transmission detection, in accordance with another preferred embodiment of the present invention. In this embodiment, bulk transmission detection is employed at least initially in spam decision functionality, symbolized by a detective 100, which receives bulk transmission classification inputs from transmission detection functionality and makes a spam/no spam decision based on these inputs. If an incoming message is determined to be spam, it is not sent to the addressee, as symbolized by an arrow pointing to a trash bin 102. If an incoming message is determined not to be spam it is sent to a recipient 104.

Characteristics of messages which are determined to be spam by the bulk transmission detection functionality and characteristics of messages which are determined not to be spam by the bulk transmission detection functionality are used to train characteristic-based classification functionality.

As seen in FIG. 2, characteristics of messages determined to be spam, here represented by a thief 110, such as the word “sex”, symbolized by apple 30, a message whose body consists of an image, symbolized by acorn 32 and a non-existent source address, symbolized by tulips 34 may be assigned a high spam classification level, symbolized by snake 36. 100601 Characteristics of messages determined not to be spam, here represented by a baby 120, such as the word “interdisciplinary”, symbolized by a banana 42 and the names of the recipient's children, symbolized by wheat 44 may be assigned a low spam classification level, symbolized by lamb 46.

Characteristics not found in either of the messages determined not to be spam and the messages determined to be spam, or characteristics found generally in both such as times of messages may be assigned an indeterminate spam classification level, symbolized by chameleon 40.

It is appreciated that in this way, the criteria for characteristic-based classification may be developed empirically.

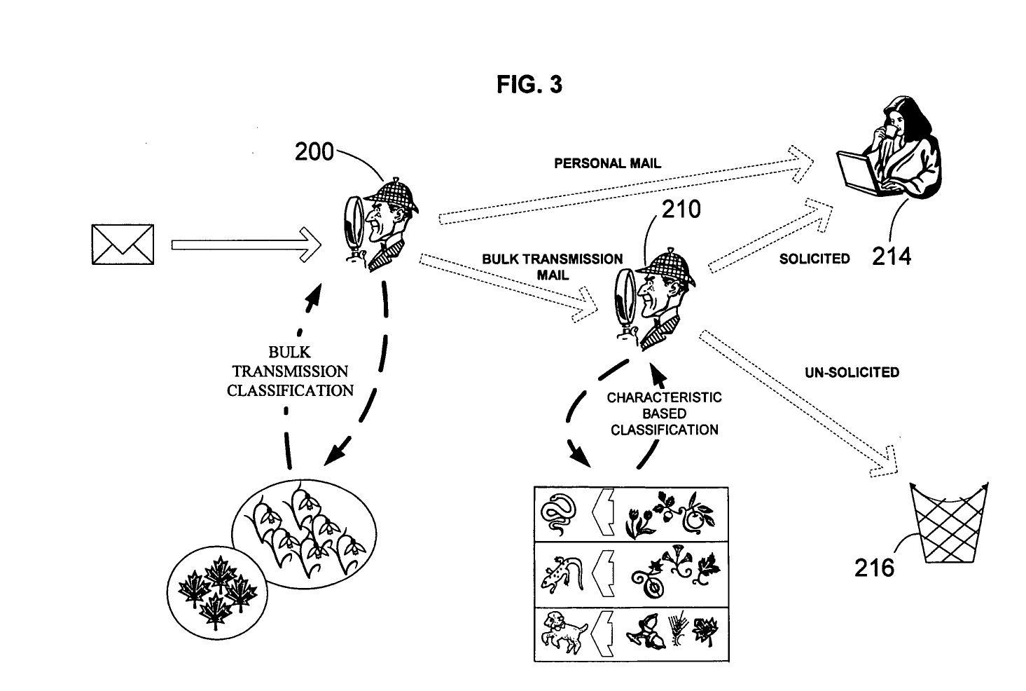

Reference is now made to FIG. 3, which is a simplified symbolic illustration of methodology for combating spam which employs both bulk transmission detection and characteristic classification in sequence. In this embodiment, bulk transmission detection is employed at least initially in spam decision functionality, symbolized by a detective 200, which receives bulk transmission classification inputs from transmission detection functionality and makes an initial spam/no spam decision based on these inputs.

If an incoming message is determined by bulk transmission criteria to possibly be spam, it is not sent to the addressee, but is rather further examined using characteristic-based classification functionality, as symbolized by a detective 210. If an incoming message is determined not to be spam it is sent to a recipient 214.

The further examination, symbolized by detective 210, preferably employs characteristic-based classification functionality, as described hereinabove with reference to FIG. 1. Based on characteristic -based criteria, a decision is made to classify the incoming message either as legitimate, e.g. solicited bulk transmission, and to send it to recipient 214 or to classify it as illegitimate, e.g. unsolicited bulk transmission, and to discard it, as symbolized by an arow directed to a trash bin 216.

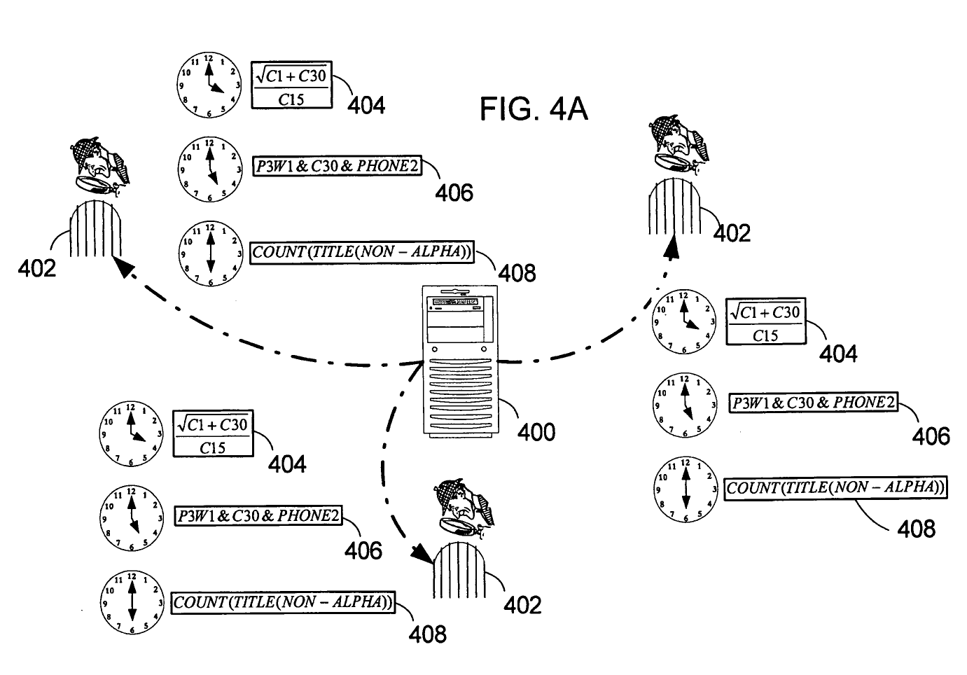

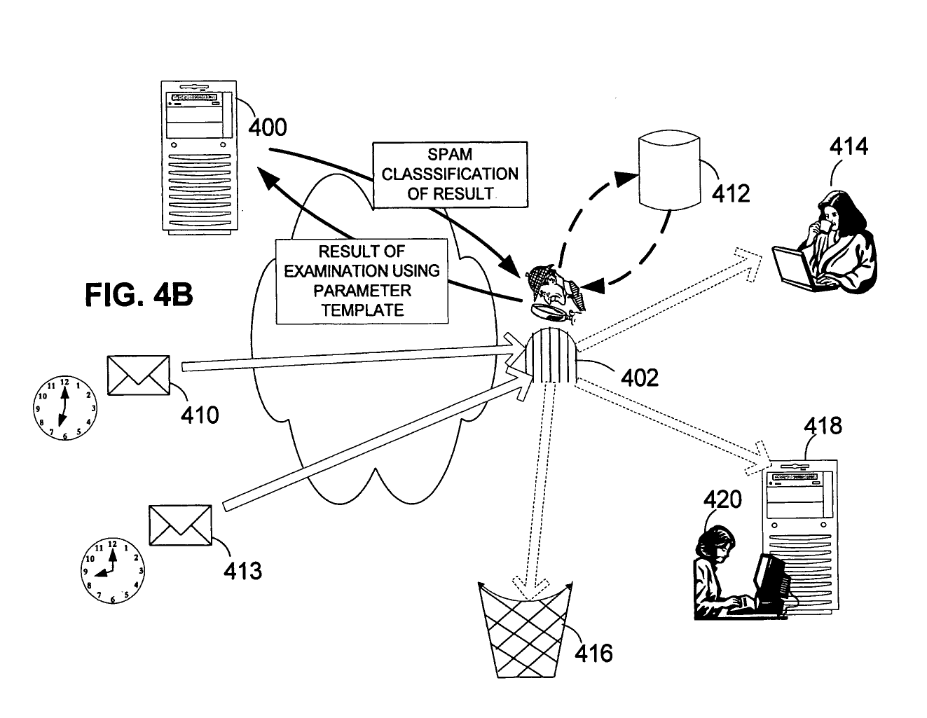

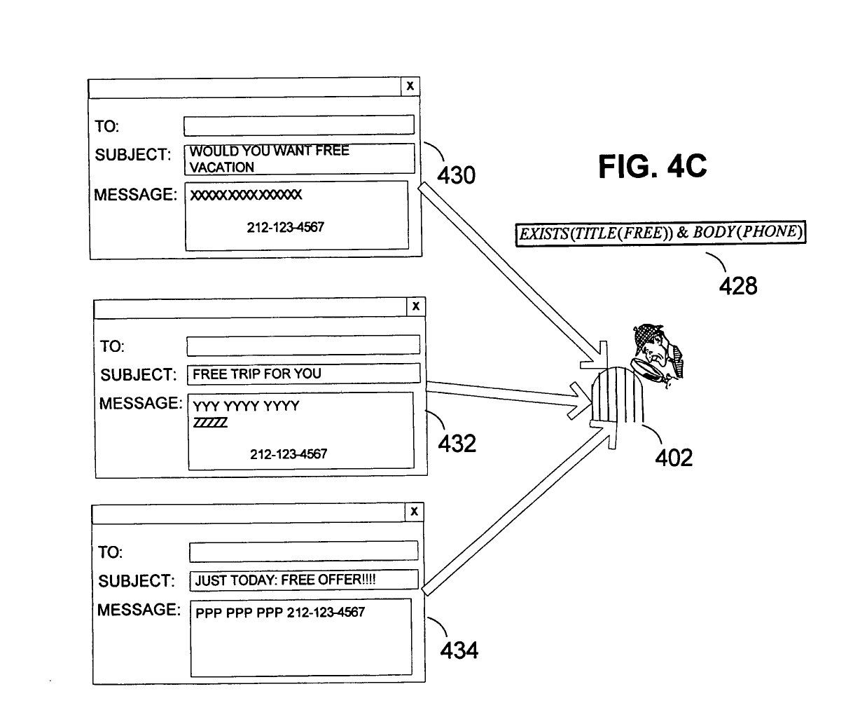

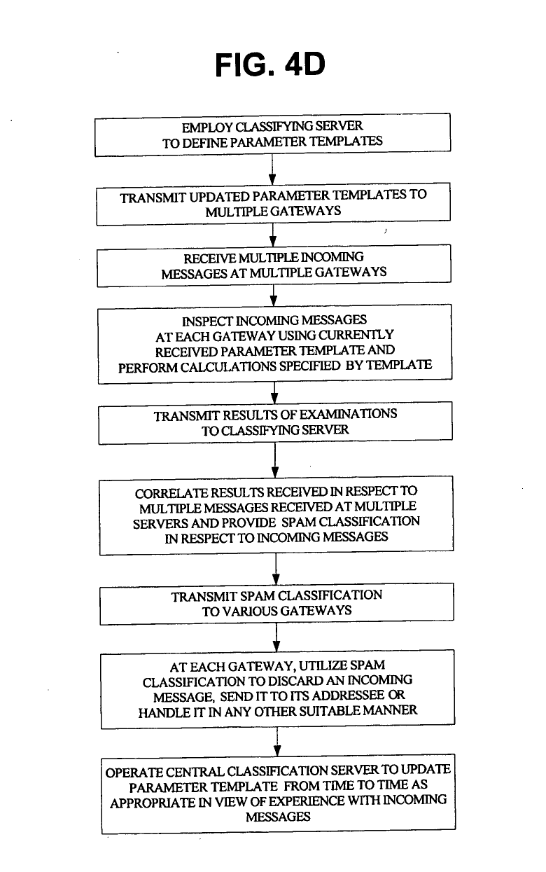

Reference is now made to FIGS. 4A-4D, which illustrate a system and methodology for combating spam in accordance with a preferred embodiment of the present invention. The system and methodology of this embodiment of the present invention employ an antispam technique comprising bulk transmission detection of incoming messages received at multiple gateways at a central server.

As seen in FIG. 4A, a bulk transmission detection server 400 may update, from time to time, a plurality of gateways 402 with parameter templates, such as parameter templates 404, 406 and 408.

It is appreciated that parameter templates may relate to characteristics of e-mail messages.

It is further appreciated that various types of parameter templates may be employed. For example, a template may include one or more of the following parameters: specific characters and/or words and/or character sequences at specific fixed or relative locations in the title, specific characters and/or words and/or character sequences at specific fixed or relative locations in the message body, e mail attributes in the body of the message, telephone number attributes in the body of the message, verbs in the body of the message and any other message attribute or part of a message attribute.

It is further appreciated that a relative location may be relative to any sub-object, such as a paragraph, a word or a formatting tag. It is also appreciated that a character sequence may be, for example, a fixed length sequence and/or a sequence delimited by a predetermined second character sequence and/or a sequence matching a pattern, such as a regular expression.

It is furthermore appreciated that a parameter template may also include instructions for calculating weightings and other values based on the various parameters.

One example of a parameter template, indicated in FIG. 4A by reference numeral 404, is as follows:
ADD THE NUMERICAL VALUE OF THE FIRST CHARACTER IN A MESSAGE BODY TO THE NUMERICAL VALUE OF THE THIRTIETH CHARACTER IN THE MESSAGE BODY;
CALCULATE THE SQUARE ROOT OF THE RESULT;
DIVIDE THE RESULT BY THE NUMERICAL VALUE OF THE FIFTEENTH CHARACTER IN THE MESSAGE BODY; AND
SET THE RESULT AS THE RESULT OF THE MESSAGE EXAMINATION.

Yet another example of a parameter template, indicated in FIG. 4A by reference numeral 406, is as follows:
CONCATENATE THE FIRST WORD OF THE THIRD PARAGRAPH OF A MESSAGE BODY AND THE THIRTIETH CHARACTER IN THE MESSAGE BODY;
CONCATENATE THE RESULT AND THE SECOND TELEPHONE NUMBER LOCATED IN THE MESSAGE BODY; AND
SET THE RESULT AS THE RESULT OF THE MESSAGE EXAMINATION.

Yet another example of a parameter template, indicated in FIG. 4A by reference numeral 408 is as follows:
LOCATE ALL NON-ALPHABETIC CHARACTERS IN A MESSAGE TITLE;
COUNT THE NUMBER OF CHARACTERS LOCATED; AND
SET THE RESULT AS THE RESULT OF THE MESSAGE EXAMINATION.

As seen in FIG. 4B, a message 410 received at a gateway 402 is examined based on at least one of a characteristic of the message and a parameter template, such as any of templates 404, 406 or 408, which may be updated from time to time by bulk transmission detection server 400. The result of the message examination is supplied by gateway 402 to bulk transmission detection server 400, which determines a bulk transmission classification for message 410.

The bulk transmission classification may be message examination result specific and/or may be message specific. It is appreciated that gateway 402 and/or bulk transmission detection server 400 may calculate weightings and other values based on results of examination of a message according to multiple characteristics and/or parameter templates to determine the bulk transmission classification of the message.

For examples, results of examination of a message according to parameter templates 404, 406 and 408 for message 410 may be 0.2, “Forp800-123-4567” and 5 respectively. A bulk transmission classification of these results may be low spam suspicion, high spam suspicion and medium spam suspicion respectively and a numerical representation of the bulk transmission classifications of these results may be 2, 9 and 6 on a 1-10 scale. By providing relative weighting to these characteristics, bulk transmission detection server 400 may calculate the bulk transmission classification of message 410. The weighting for parameter templates 404, 406 and 408 may be 0.3, 0.5 and 0.2 respectively, and the bulk transmission classification of message 410 would therefore be 2*0.3+9*0.5+6*0.2=6.1 on a 1-10 scale.

Bulk transmission classifications and/or examination results and/or message attributes may be stored at the server 400, gateway 402 or using any other storage functionality 412 and employed for examination and/or classification of later received messages, such as a message 413.

Additionally or alternatively, bulk transmission detection server 400 may transmit bulk transmission classifications to multiple ones of the plurality of gateways 402.

It is appreciated that according to a preferred embodiment of the present invention, a bulk transmission detection gateway 402 may employ a non-reversible encryption algorithm so as to generate an encrypted transformation of at least part of a message parameter. It is appreciated that the encrypted information may be shorter than any reversible transformation of at least part of a message parameter, so as to consume less network resources when transmitted through a network. It is further appreciated that the encrypted information is incomprehensible to bulk transmission detection server 400 so as to avoid revealing any confidential information contained in a message. It is further appreciated that the amount of information transmitted from a gateway 402 to server 400 may be limited according to a predefined threshold.

Based on a bulk transmission classification of a message, bulk transmission detection gateway 402 may perform any one or more of the following actions with the message 410: a message having low spam certainty may be forwarded to an addressee, such as a user 414, a message having high spam certainty may be deleted, as indicated by being sent to a symbolic trash bin 416, and a message having intermediate spam certainty may be parked in an appropriate storage medium 418 until an appropriate later time when a new classification is made automatically or as the result of manual inspection by an administrator 420.

It is further appreciated that bulk transmission detection server 400 may classify a message by correlating the results of examination of a multiplicity of messages received by gateways 402 using a single or multiple parameter templates. High correlations tend to indicate the existence of spam and result in a spam classification being sent by server 400 to gateways 402.

It is appreciated that bulk transmission detection server 400 may employ any one or more of the following methods to correlate results of examination: an exact match, an approximate match and a cross-match. The bulk transmission detection server 400 may employ any other suitable correlation method. An exact match may be determined by comparing each character of a string representation of a result of examination for a first message with the character in the same position of the string representation of a result of examination for a second message. It is further appreciated that if all the comparisons are positive, the results match. Alternatively or additionally, an exact match may be determined by comparing a value calculated by applying a non-reversible encryption function to a result of examination of a first message and a non-reversible encryption function to a result of examination of a second message. Alternatively or additionally, an exact match may be determined by comparing any suitable one-to-one transformations of a result of examination of a first message with a one-to-one transformation of a result of examination of a second message.

It is appreciated that an approximate match may be determined by comparing an equivalent of a result of examination of a first message to an equivalent of a result of examination of a second message. Alternatively or additionally, an approximate match may be determined by comparing any suitable many-to-many transformation of a result of examination of a first message with a many-to-many transformation of a result of examination of a second message.

It is appreciated that a cross-match may be determined by comparing any suitable transformation of a result of examination of a first message using a first parameter template with a suitable transformation of a result of examination of a second message using a second parameter template.

Referring to FIG. 4C, another example of a parameter template 428 may be:
CONCATENATING THE WORD “FREE” IF IT EXISTS IN A MESSAGE TITLE AND THE FIRST TELEPHONE NUMBER LOCATED IN THE MESSAGE BODY.

As further seen in FIG. 4C, if bulk transmission detection gateway 402 receives non-identical messages 430, 432 and 434, notwithstanding the differences in the messages 430, 432 and 434 the result of examination thereof may yield identical calculated values. In the event that a significant number of messages having this calculated value are received within a predetermined time, gateway 402 classifies all of these messages, notwithstanding their differences, as being spam.

It is appreciated that gateway 402 need not be located along the original route of a message. A message may be redirected to gateway 402 by any suitable gateway through which the message passes. Additionally or alternatively, a suitable gateway may send a copy of the message to gateway 402.

Reference is now made to FIG. 4D, which is a simplified flowchart illustrating the functionality of the embodiment of FIGS. 4A-4C. As seen in FIG. 4D, bulk transmission detection server 400 may be employed to define parameter templates which may change over time and which may additionally specify calculations to be performed by gateways 402. Updated parameter templates may be provided from time to time to multiple gateways 402, which receive a multiplicity of incoming messages. The gateways 402 inspect the incoming messages using the current parameter templates and perform calculations specified by the templates.

Results of the examination are transmitted by the gateways 402 to bulk transmission detection server 400, which may correlate the results received in respect of plural messages from multiple servers and which provides bulk transmission classifications, which are supplied to the spam detection gateways 402.

The individual gateways employ the spam classifications to discard an incoming message, send it to its addressee or handle it in any other suitable manner, as described hereinabove. The bulk transmission detection server may update the parameter templates from time to time, based inter alia on its experience with earlier incoming messages. It is appreciated that the embodiment of FIGS. 4A-4D is also applicable to a single gateway architecture. In such a case, changeable templates may be generated at the gateway and spam determinations may be made thereby without involvement of an external server, preferably based on correlations between multiple messages received at that gateway. Inputs from other gateways may also be employed.

It is further appreciated that an additional anti-spam technique employs “parking” suspect messages until further information, which could assist in their classification, becomes available. For example, a message, which is classified by a gateway as being legitimate, may be sent without delay through the gateway to an addressee. Another message, which is classified by the gateway as being spam, may be deleted by the gateway. Yet another message, which cannot be classified with acceptable certainty according to appropriate criteria based on the information available at the gateway, may be stored or “parked” on a suitable storage medium, such as a file server.

Examples of an appropriate method employed by the gateway for classifying the spam level messages may include any one or more of the techniques: analysis of the message content; analysis of the message header; transmission of the message and/or parts of it, preferably in non-reversible encrypted form, to a server; determination of compliance of the message content and/or the message headers with a predefined policy and requesting feedback from the message addressee.

Within a suitable time, such as one hour, if further information, such as a message similar to one of said messages is received at the gateway, a decision may be made based on appropriate criteria to delete both said one of said messages and subsequently received message. Alternatively, a decision may be made at any suitable time based on appropriate criteria to send any of said messages to an addressee.

The foregoing methodology may be combined with any one or more of the methodologies described hereinabove with reference to FIGS. 1-3.

It is further appreciated that an additional anti-spam technique relates to an ‘unsubscribe’ functionality of messages. A first message having a general unsubscribe feature, which does not contain any information regarding the message addressee, is classified by spam inspecting gateway as having a high likelihood of being spam and is therefore discarded. A second message, having an unsubscribe feature which includes an addressee's email address, is classified by the gateway as having an intermediate likelihood of being spam and is sent to a temporary storage location, to await manual classification by an email administrator. The presence of the addressee's email address may indicate the existence of a recipient database which is not characteristic of spam. A third message, having an unsubscribe feature which includes a user identification number, is presumed to indicate the existence of a user database and is therefore presumed not to be spam. This message is therefore sent to an addressee.

The foregoing methodology may be combined with any one or more of the methodologies described hereinabove with reference to FIGS. 1-3.

It is further appreciated that the unsubscribe feature in a message may include a network reference, such an address of a web service which enables a user to be removed from a list generating the message and/or from other address lists. Alternatively or additionally, an unsubscribe functionality may include a mail address to which an unsubscribe request may be sent in order to remove the user from a mailing list generating the message and/or from other address lists.

It is further appreciated that an unsubscribe feature may be identified by locating predefined keywords in a message. Examples of a typical predefined keyword may include “unsubscribe”, “exclude”, “future mailing” and any other suitable keyword. Alternatively or additionally, an unsubscribe feature may be identified by a reference to a message addressee.

It is further appreciated that an additional anti-spam technique relates to the presence of unsubscribe functionality in incoming messages. A spam inspecting gateway inspects an incoming message having an unsubscribe feature in order to determine a spam classification of the message. The inspecting gateway initially actuates the unsubscribe feature by communicating with a server which is typically addressed by the unsubscribe feature. A spam classification is determined based on a response received from the server. In the illustrated example, receipt of an error response indicating that the unsubscribe function does not exist may indicate a relatively high spam certainty. An error response indicating that the unsubscribe function does exist but is not operating properly may indicate an intermediate spam certainty and an error message indicating successful initial actuation of the unsubscribe function may indicate a relatively low spam certainty, without actually causing the addressee to be unsubscribed.

The foregoing methodology may be combined with any one or more of the methodologies described hereinabove with reference to FIGS. 1-3.

It is further appreciated that the unsubscribe feature in a message may include a network reference, such an address of a web service which enables a user to be removed from a list generating the message and/or from other address lists. Alternatively or additionally, an unsubscribe functionality may include a mail address to which an unsubscribe request may be sent in order to remove the user from a mailing list generating the message and/or from other address lists.

It is further appreciated that an unsubscribe feature may be identified by locating predefined keywords in a message. Examples of a typical predefined keyword may include “unsubscribe”, “exclude”, “future mailing” and any other suitable keyword. Alternatively or additionally, an unsubscribe feature may be identified by a reference to a message addressee.

It is further appreciated that another anti-spam technique relates to registration status of the domain name or any other registered address in an incoming message. An inspector gateway inspects an incoming message having a domain indication or any other registered address. The inspector gateway may employ a look up directory to check the registration date and/or the expiry date of the domain indication. Relatively newly registered addresses may indicate a high certainty of spam. Additionally or alternatively, a registered address for which registration has expired may indicate a high certainty of spam. Additionally or alternatively, a parked status, as explained below, may indicate a higher level of indication of spam.

The foregoing methodology may be combined with any one or more of the methodologies described hereinabove with reference to FIGS. 1-3.

It is further appreciated that a registered network address may be a network reference at least a part of which requires registration at a registry prior to use. A registered network address may be an Internet domain name and/or any network address that comprises an Internet domain name, such as an Internet email address or a URL. An expired registered address may be a registered address for which a periodic registration was required and was not performed. It is further appreciated that the registration date of a registered network address may be the date on which the address was first registered. The term “parked status” typically refers to a domain that was registered but does not refer to an operative web site.

It is further appreciated that yet another additional anti-spam technique relates to matching various addresses appearing in an incoming message. The additional anti-spam technique comprises an inspector gateway inpecting an incoming message having a domain name indication or any other translatable reference and at least one other reference, such as an IP address. The inspector gateway may employ a look up directory to translate the domain name indication and/or any other translatable reference and then may compare one or more translated references to any one or more references and/or other translated references in the message in order to ascertain the presence of matches. Matches indicate a relatively low spam certainty.

The foregoing methodology may be combined with any one or more of the methodologies described hereinabove with reference to FIGS. 1-3.

It is further appreciated that a translatable reference may be a reference at least a part of which may be translated by querying a translation service. A symbolic Internet host name, for example, can be translated to a numeric IP address by employing an Internet domain registry service. As another example, a translatable reference may be any network address including a symbolic Internet host name such as an e-mail address or a URL.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1. A method for combating spam comprising:
performing bulk tranmission detection on incoming messages;
performing characteristic -based classification on at least one incoming message; and
employing results of both said bulk transmission detection and said characteristic -based classification for filtering at least one incoming message.

2. A method for combating spam according to claim 1 and wherein said filtering incoming messages operates on at least one incoming message which is at least partially different from said incoming messages on which said bulk transmission detection is performed and said at least one incoming message on which said characteristic -based classification is performed.

3. A method for combating spam according to claim 1 and wherein said performing bulk transmission detection is performed on first incoming messages;
said performing characteristic-based classification is performed on at least one second incoming message; and
said filtering is performed on at least one third incoming message, wherein said at least one third incoming message is at least partially different from at least one of said first incoming messages and said at least one second incoming message.

4. A method for combating spam according to claim 1 and wherein said performing bulk transmission detection and said performing characteristic classification employ at least some of the same characteristics.

5. A method for combating spam according to claim 1 and wherein said performing characteristic-based classification comprises a training functionality.

6. A method for combating spam according to claim 5 and wherein said training functionality employs at least some of said results of said performing bulk transmission detection.

7. A method for combating spam according to claim 1 and wherein at least some of said results of said characteristic-based classification are employed in said bulk transmission detection.

8. A method for combating spam according to claim 7 and wherein said results of said characteristic -based classification are employed for distinguishing between different categories of bulk transmissions.

9. A method for combating spam according to claim 7 and wherein said results of said characteristic -based classification are employed for distinguishing between solicited and non-solicited bulk transmissions.

10. A method for combating spam according to claim 1 and wherein said characteristic -based classification employs Bayesian probability models.

11. A method for combating spam according to claim 1 and wherein said performing bulk transmission detection comprises classifying a message at least partially by evaluating at least one message parameter, using at least one variable criterion, thereby providing a spam classification.

12. A method for combating spam according to claim 11 and wherein said at least one variable criterion comprises a criterion which changes over time.

13. A method for combating spam according to claim 11 and wherein said at least one variable criterion comprises a parameter template-defined function.

14. A method for combating spam according to claim 1 and wherein said filtering comprises:
evaluating incoming messages at at least one gateway; and
providing spam classifications at at least one server, receiving evaluation outputs from said at least one gateway and providing said spam classifications to said at least one gateway.

15. A method for combating spam according to claim 14 and wherein said receiving evaluation outputs comprises transmitting encrypted information from said at least one gateway to said at least one server.

16. A method for combating spam according to claim 15 and wherein said transmitting encrypted information comprises encrypting at least part of said evaluation output employing a non-reversible encryption algorithm so as to generate said encrypted information at said at least one gateway.

17. A method for combating spam according to claim 15 and wherein said transmitting comprises transmitting information of a length limited to a predefined threshold.

18. A method for combating spam according to claim 1 and wherein said filtering at least one incoming message comprises at least one of:
forwarding said message to an addressee of said message;
storing said message in a predefined storage area;
deleting said message;
rejecting said message;
sending said message to an originator of said message; and
delaying said message for a period of time and thereafter re-classifying said message.

19. A method for combating spam according to claim 1 and wherein said incoming messages comprise at least one of:
an e-mail;
a network packet;
a digital telecom message; and
an instant messaging message.

20. A method for combating spam according to claim 1 and wherein said filtering also comprises at least one of:
requesting feedback from an addressee of said message;
evaluating compliance of said message with a predefined policy;
evaluating registration status of at least one registered address in said message;
analyzing a match among network references in said message;
analyzing a match between at least one translatable address in said message and at least one other network reference in said message;
at least partially actuating an unsubscribe feature in said message;
analyzing an unsubscribe feature in said message;
employing a variable criteria;
sending information to a server and receiving classification data based on said information;
employing classification data received from a server; and
employing stored classification data.
